(19) United States
(12) Patent Application Publication
(10) Pub. No.: US 2008/0252840 A1
(43) Pub. Date: Oct. 16, 2008

(54) Liquid Crystal Display and Support Structure Thereof

(75) Inventor: Ya-Chieh Chen, Hsinchu (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: AU OPTRONICS CORP., Hsinchu (TW)

(21) Appl. No.: 12/017,189

(22) Filed: Jan. 21, 2008

(30) Foreign Application Priority Data
Apr. 16, 2007 (TW) 96113322

(51) Int. Cl. G02F 1/1339

(52) U.S. Cl. 349/155

(57) ABSTRACT

A liquid crystal display (LCD) and a support structure of the LCD are provided. The LCD comprises a first substrate and a second substrate, wherein a plurality of scan lines and data lines are disposed on the second substrate to define a plurality of display units. The support structure comprises a control module assembly and a plurality of spacers. Each of the spacers is disposed on the first substrate and independently disposed along the scan lines corresponding to each display unit. Furthermore, some of the spacers come into contact with the control module assembly, which is disposed on the second substrate, while the other spacers individually form a gap with the control module assembly.

This application claims the benefits of the priority based on Taiwan Patent Application No. 096113322 filed on Apr. 16, 2007; the disclosures of which are incorporated by reference herein in their entirety.

### CROSS-REFERENCES TO RELATED APPLICATIONS

Not applicable.

### BACKGROUND OF THE INVENTION

1. Field of the Invention

The present invention relates to a liquid crystal display and a support structure thereof. Particularly, the present invention relates to a support structure with spacers that are correspondingly disposed along the scan lines in a vertical alignment liquid crystal display.

2. Descriptions of the Related Art

LCDs have replaced conventional monitors in the display market due to their low power consumption, light weight, low radiation and good portability. In general, an LCD comprises a backlight module, liquid crystal panel and color filter. The liquid crystal panel comprises an upper substrate, a lower substrate and liquid crystals being filled between the two substrates. The twisted orientation of the liquid crystals in the pixels can be controlled by the control elements on the substrates, so that the luminance of the pixels can be adjusted by letting varying amounts of light from the backlight module through the apparatus.

Conventionally, ball spacers are used to create a gap between the upper and lower substrates so that liquid crystals may be filled between the upper substrate (typically a color filter substrate) and lower substrate (typically a thin film transistor substrate). However, the size and location of the conventional ball spacers are difficult to control, often resulting in an uneven space between the substrates. As a result, photo-spacers are now used in place of the conventional ball spacer because their photolithography technology allows for more size and location control.

In addition, mixed photo-spacers can be used to support the substrates when the liquid crystals are filled using the one drop fill (ODF) process. The performance at the borders of the pixels can be improved due to the structure of the photo-spacers. That is, the photo-spacers comprise main photo-spacers and sub photo-spacers both disposed on the upper substrate but at different locations and with different shapes and distribution proportions. The main photo-spacers are placed against the lower substrate directly, while the sub photo-spacers form a gap with the lower substrate. When the substrates are subjected to an external force, the sub photo-spacers align along the lower substrate for additional support.

However, even with this type of spacer, there are still disadvantages. For example, the different locations of the spacers will directly affect the aperture ratio of the pixels. In vertical alignment LCDs, the inappropriate spacer disposition may affect the rotation angle of the liquid crystals. With the different size and distribution patterns, the sizes of both kinds of photo-spacers must be monitored during the manufacturing process of the color filter, resulting in difficult monitoring processes. Additionally, in the conventional spacer distribution pattern, the spacers are disposed with a relatively large pitch, giving rise to insufficient support.

Thus, it is important to provide a liquid crystal display and a support structure thereof that can provide sufficient support, while maintaining the aperture ratio of the pixels.

### SUMMARY OF THE INVENTION

The primary objective of this invention is to provide a liquid crystal display and a support structure thereof. Because the scan lines per se have a certain thickness, the spacers are correspondingly disposed along the scan lines in the support structure of this invention. Furthermore, the spacers will not affect the aperture ratio of the pixels, nor will their shapes affect the alignment and rotation of the liquid crystals because the spacers are not disposed in the display area.

Another objective of this invention is to provide a liquid crystal display and a support structure thereof, in which the spacers are disposed on the color filter substrate in a periodical arrangement. Since the spacers can all be of the same size, the manufacturing process can be simplified. In the manufacturing process of the control module of the thin film transistor (TFT) substrate, some areas are purposely designed to have a thicker structure for making contact with some of the spacers, while other areas are designed to have a thinner structure to keep separate itself from the spacer. Again, the spacers can only provide auxiliary support when the substrates are pressed. In other words, the distribution proportions of the two kinds of spacers can be decided in this invention by determining the different thickness of the control module.

Yet a further objective of this invention is to provide a liquid crystal display and a support structure thereof. The structure of this invention can be easily integrated into the manufacturing process. For example, when the data lines are being deposited, a metallic layer that is only used to increase the thickness, but serves no conductive function, can be formed in some areas of the scan lines to increase the thickness of these areas. With the provision of this metallic layer, different spaces will be formed between the control module and the spacers, so that after the ODF process, the liquid crystal borders will have a better performance and the panel will have a high resistance to compression.

To achieve the abovementioned objectives, this invention discloses a liquid crystal display and a support structure thereof. The liquid crystal display comprises a first substrate, a second substrate, a vertical alignment liquid crystal layer, a plurality of scan lines, a plurality of data lines and a plurality of display control elements. The scan lines and the data lines are formed on the second substrate to define the display units, while the display control elements are disposed on the display units to correspond respectively to a scan line and a data line. The support structure comprises a control module assembly and a spacer assembly, wherein the spacer assembly is disposed on the first substrate and facing toward the control module assembly, which is disposed on the second substrate. The spacer assembly comprises a plurality of first spacers and a plurality of second spacers. The control module assembly is divided into a plurality of first control modules and a plurality of second control modules, wherein the first spacers are at least partially in contact with the first control modules, and an interval is formed between the second spacers and the second control modules. The first and second spacers are correspondingly disposed on the display units respectively. All spacers are disposed along the scan lines of the second substrate correspondingly.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 is a schematic view illustrating an LCD;

FIG. 2 is a partial top view illustrating the LCD structure of the present invention;

FIG. 3 is a schematic cross-sectional view illustrating a portion of spacers of the present invention that are directly in contact with the control module; and

FIG. 4 is a schematic cross-sectional view illustrating the other spacers of the present invention that form an interval with the control module.

### DESCRIPTION OF THE PREFERRED EMBODIMENT

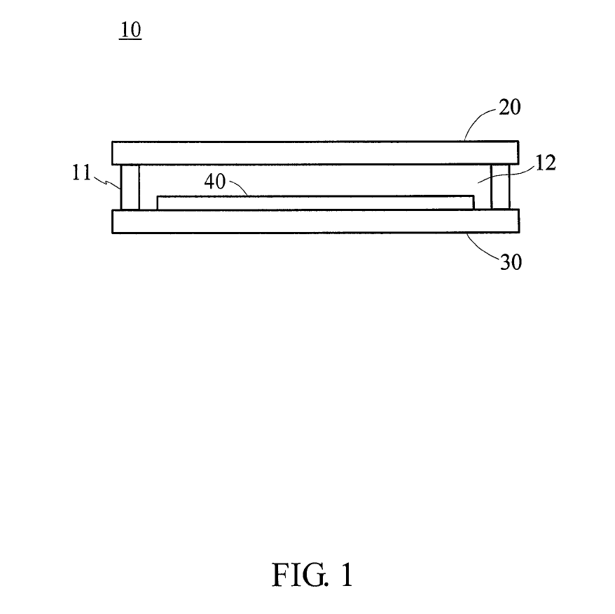

FIG. 1 is a schematic view illustrating an LCD 10. The LCD 10 comprises a first substrate 20, a second substrate 30 and a control module assembly 40. The control module assembly 40 is disposed on the second substrate 30 to help control the luminance of the individual display pixels. Additionally, a liquid crystal layer 12, such as a vertical alignment (VA) liquid crystal layer, is encapsulated between the first substrate 20 and the second substrate 30 with a sealing structure 11 disposed on the periphery of the substrates. The first substrate 20 is generally a color filter substrate, while the second substrate 30 is generally a TFT substrate.

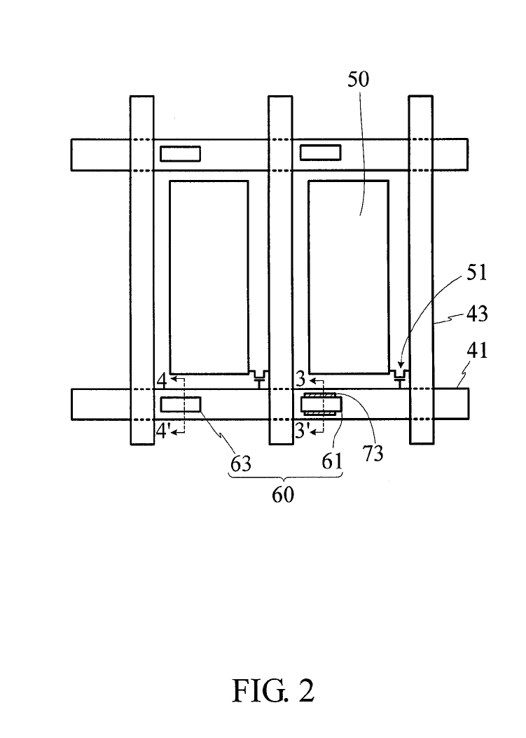

In FIG. 2, a partial top view of the LCD 10 is depicted to illustrate the detailed structure more clearly. The second substrate 30 has a plurality of scan lines 41, a plurality of data lines 43 and a control module assembly 40 formed thereon, wherein the scan lines 41 and the data lines 43 are adapted to define a plurality of display units 50. The second substrate 30 has a plurality of display control elements 51 disposed thereon, for example, a plurality of TFTs, such as those with bottom-gate structures. The display control elements 51 are correspondingly disposed on the display units 50 and connected to a scan line 41 and a data line 43 respectively. The twist of the liquid crystals in the display units 50 is then controlled by both the display control elements 51 and the signals transferred through the scan lines 41 and data lines 43 to determine whether to let light in or not.

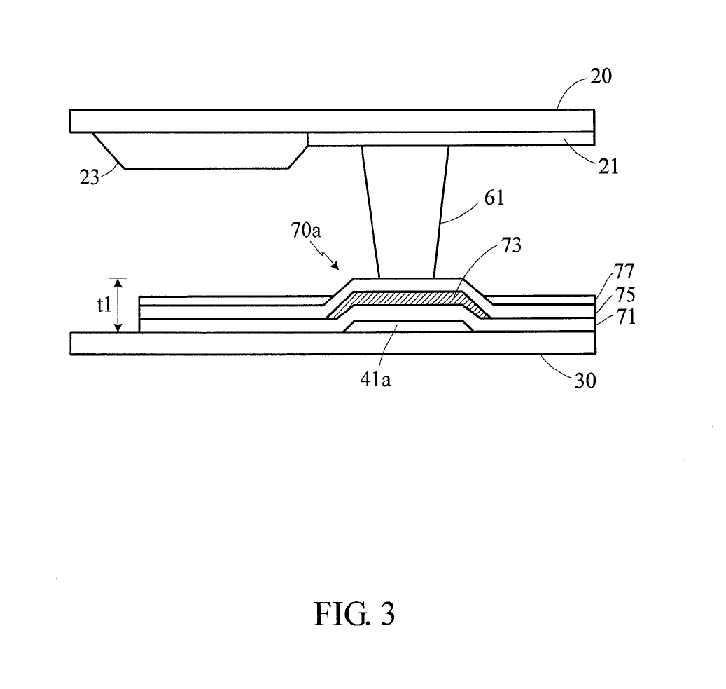

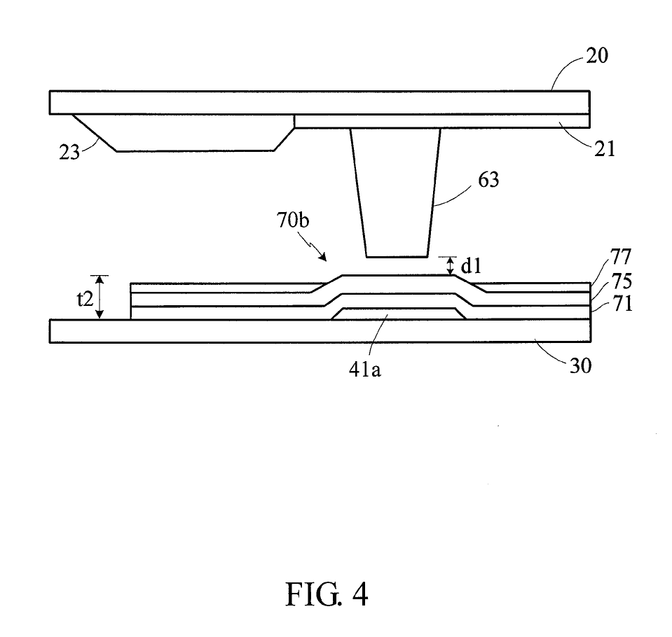

While the control module assembly 40 is disposed on the second substrate 30, a spacer assembly 60 is disposed on the first substrate 20 corresponding to the display units 50 and facing toward the control module assembly 40. The spacer assembly 60 comprises a plurality of spacers, and more particularly, a plurality of first spacers 61 and a plurality of second spacers 63. This invention is unique in that the first spacers 61 and second spacers 63 are both disposed along the scan lines 41, thus, maintaining the aperture ratio of the display units 50. A cross-sectional view along line 3-3′ from FIG. 2 is depicted in FIG. 3, while a cross-sectional view along line 4-4′ is depicted in FIG. 4. The first spacers 61 partially come into contact with the control module assembly 40, while an interval d1 is formed between the second spacers 63 and the control module assembly 40.

The control module assembly 40 can be divided into a plurality of first control modules 70a corresponding to the first spacers 61 and a plurality of second control modules 70b corresponding to the second spacers 63. More specifically, the first control modules 70a of the present invention has a first thickness t1, while the second control modules 70b has a second thickness t2 that is smaller than the first thickness t1. In this way, the first control modules 70a can come into contact with the first spacers 61, while an interval d1 is formed between the second control modules 70b and the second spacers 63.

With the first spacers 61 directly in contact with the first control modules 70a, at least an interval is maintained between the first substrate 20 and the second substrate 30 for receiving the liquid crystals. Furthermore, once the panel is pressed, the second spacers 63 will press against the second control modules 70b to provide auxiliary support.

Referring back to FIG. 3, each of the first control modules 70a comprises a first metallic layer 41a, a dielectric layer 71, a second metallic layer 73, a passivation layer 75 and a transparent electrode 77 that are sequentially stacked to form the first thickness t1. The second metallic layer 73 can be formed using the same manufacturing process as the data lines 43, but remains insulated from the data lines 43, i.e., the second metallic layer 73 does not serve any conductive function, but is only used to increase the first thickness t1 of the first control modules 70a. The advantage is that in the technology disclosed in the present invention, no other manufacturing process is needed to increase the first thickness t1. It should be noted that, the first metallic layer 41a is electrically connected to the scan lines 41, and in fact, the first spacers 61 and the second spacers 63 can be directly formed along the scan lines 41. Since the first spacers 61 and the second spacers 63 are located on the scan lines 41 between the pixels, the aperture ratio and liquid crystal twists are maintained. As a result, the pixel performance is unaffected. Furthermore, this invention can be easily integrated into conventional processes to lower manufacturing costs. Additionally, to increase the first thickness t1 of the first control modules 70a, any layered structure thereof can be designed to increase its thickness during the manufacturing process to reach the objective of the present invention. As is well known, the first substrate 20 also has a black matrix structure 21 and a light filtering layer 23 disposed thereon, which are well-known to those people skilled in this field and will not be described herein.

Referring back to FIG. 4, each of the second control modules 70b comprises a first metallic layer 41a, a dielectric layer 71, a passivation layer 75 and a transparent electrode 77 that are sequentially stacked to form the second thickness t2. Since the second control modules 70b don't need an increased thickness, the second thickness t2 will be thinner than the first thickness t1 of the first control modules 70a, and therefore an interval d1 is formed between the second control modules 70b and the second spacers 63.

The aforesaid first spacers 61 and the second first spacers 63 are preferably made of photosensitive materials. Also, the amount of first spacers 61 compared to the second spacers 63 ranges from 1:1 to 1:20. The technology of this invention is especially suitable for use in the vertical alignment (VA) LCD.

In accordance with the technology disclosed herein, the spacers of the LCD are all disposed along the scan lines in a mixed distribution, in which some spacers directly press against the control module, while others form an interval with the control module depending on the thickness of the scan lines. This can provide sufficient support without the need of any additional processes and without changing the aperture ratio of the display pixels.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A support structure for use in a liquid crystal display, the liquid crystal display comprising a first substrate, a second substrate, a plurality of scan lines and a plurality of data lines, in which the scan lines and the data lines are disposed on the second substrate to define a plurality of display units, the support structure at least comprising:
a control module assembly, being disposed on the second substrate and correspondingly at the scan lines; and
a spacer assembly, comprising a plurality of first spacers and a plurality of second spacers in which the first and second spacers are disposed on the first substrate facing toward the control module assembly;
wherein the first spacers at least partially contact with the control module assembly, an interval is formed between the second spacers and the control module assembly, and the first and second spacers are disposed at the scan lines, correspondingly.

2. The support structure as claimed in claim 1, wherein the liquid crystal display is a vertical alignment liquid crystal display.

3. The support structure as claimed in claim 2, wherein the liquid crystal display further comprises a plurality of thin-film-transistors being disposed at the display units respectively, in which each of the thin-film-transistors has a gate structure.

4. The support structure as claimed in claim 2, wherein the control module assembly has a first thickness corresponding to the first spacers for contacting therewith.

5. The support structure as claimed in claim 4, wherein the control module assembly comprises a first metallic layer, a dielectric layer, a second metallic layer, a passivation layer and a transparent electrode being sequentially stacked to form the first thickness.

6. The support structure as claimed in claim 5, wherein the first metallic layer electrically connects with the scan line.

7. The support structure as claimed in claim 6, wherein the second metallic layer and the data line are formed in one structure layer with isolation therebetween.

8. The support structure as claimed in claim 4, wherein the control module assembly has a second thickness corresponding to the second spacers, in which the second thickness is smaller than the first thickness.

9. The support structure as claimed in claim 8, wherein the control module assembly comprises a first metallic layer, a dielectric layer, a passivation layer and a transparent electrode being sequentially stacked to form the second thickness.

10. The support structure as claimed in claim 1, wherein the second spacers and the first spacers substantially have a proportion in quantity from 1 to 20.

11. The support structure as claimed in claim 1, wherein each of the first and second spacers is made of a photosensitive material.

12. A liquid crystal display, comprising:
a first substrate;
a second substrate;
a plurality of scan lines, being disposed on the second substrate;
a plurality of data lines, being disposed on the second substrate to define a plurality of display units with the scan lines;
a plurality of display control elements, being disposed on the second substrate, wherein the display control elements are correspondingly disposed with the display units and connected with the scan lines and the data lines, respectively;
a plurality of spacers, being disposed on the first substrate corresponding to the display units respectively, and also being disposed at the scan lines on the second substrate, correspondingly; and
a plurality of first control modules and a plurality of second control modules, being disposed on the second substrate and corresponding to the spacers respectively, wherein the first control modules correspondingly contact with the spacers, and an interval is formed between each of the second control modules and the spacers.

13. The liquid crystal display as claimed in claim 12, wherein the liquid crystal display is a vertical alignment liquid crystal display.

14. The liquid crystal display as claimed in claim 13, wherein each of the display control elements is a thin-film-transistor having a gate structure.

15. The liquid crystal display as claimed in claim 13, wherein the first control modules have a first thickness for contacting with the spacers, correspondingly.

16. The liquid crystal display as claimed in claim 15, wherein each of the first control modules comprises a first metallic layer, a dielectric layer, a second metallic layer, a passivation layer and a transparent electrode being sequentially stacked to form the first thickness.

17. The liquid crystal display as claimed in claim 16, wherein the first metallic layer electrically connects with the scan line.

18. The liquid crystal display as claimed in claim 17, wherein the second metallic layer and the data line are formed in one structure layer with isolation therebetween.

19. The liquid crystal display as claimed in claim 15, wherein the second control module has a second thickness corresponding to the spacers, in which the second thickness is smaller than the first thickness.

20. The liquid crystal display as claimed in claim 19, wherein the second control module assembly comprises a first metallic layer, a dielectric layer, a passivation layer and a transparent electrode being sequentially stacked to form the second thickness.

21. The liquid crystal display as claimed in claim 12, wherein the second control modules and the first control modules substantially have a proportion in quantity from 1 to 20.

22. The liquid crystal display as claimed in claim 12, wherein each of the spacers is made of a photosensitive material.

23. A liquid crystal display, comprising:
a first substrate;
a second substrate;
a plurality of scan lines, being disposed on the second substrate;
a plurality of data lines, being disposed on the second substrate and defining a plurality of display units with the scan lines;
a vertical alignment liquid crystal layer, being disposed between the first substrate and the second substrate;
a plurality of display control elements, being disposed on the second substrate, wherein the display control elements are correspondingly disposed with the display units and connected with the scan lines and the data lines, respectively;
a plurality of spacers, being disposed on the first substrate corresponding to the display units respectively, and also being disposed at the scan lines on the second substrate, correspondingly; and
a plurality of first control module and a plurality of second control modules, being disposed on the second substrate and corresponding to the spacers respectively, wherein the first control modules correspondingly contact with the spacers, and an interval is formed between each of the second control modules and the spacers.
